(19) United States
(12) Patent Application Publication
(10) Pub. No.: US 2008/0010463 A1
(43) Pub. Date: Jan. 10, 2008

(54) METHOD FOR PRODUCING TRUNCATED MESSAGE DIGESTS

(75) Inventor: Donald E. Eastlake, Milford, MA (US)

Correspondence Address: MOTOROLA, INC., 1303 EAST ALGONQUIN ROAD, IL01/3RD, SCHAUMBURG, IL, 60196, US

(73) Assignee: MOTOROLA, INC., Schaumburg, IL (US)

(21) Appl. No.: 11/456,260

(22) Filed: Jul. 10, 2006

(51) Int. Cl. H04L 9/00

(52) U.S. Cl. 713/181

(57) ABSTRACT

A truncated message digest of length L bits is generated from a message by preprocessing the message dependent upon the value L to obtain a modified message. As part of the preprocessing, the message is lengthened by insertion of additional values. A full length message digest is generated from the modified message and the truncated message digest is obtained by truncating the full length message digest to L bits. This approach results in truncated message digests that are secure and provide a large range of truncation options.

### BACKGROUND

In cryptography, a message digest, sometimes termed a cryptographic hash value, is fixed length string that is a function of an input message string. A message digest function generally takes a variable length bit or byte string and produces a fixed length hash or fingerprint of the string. Example message digest functions include the Standard Hash Algorithms (SHA). SHA-1, for example produces a message digest value (hash value) of length 160 bits, while other defined functions in the series, SHA-224, SHA-256, SHA-384 and SHA-512, produce message digest values containing the number of bits as specified in their names. Other, related, message digest functions include those defined in standards MD4 and MD5, for example.

For cryptographic use, a message digest function is considered insecure if it is feasible to find two different message strings that produce the same digest value (this is known as a “collision”) or if it is feasible to find a message that matches a given digest value other than by a brute force search of on average 2^{N-1} values, where N is the number of bits in the digest value (that, is the computation should be “one way”).

The SHA and MD functions utilize the Merkle-Damg [symbol] rd structure in which a message is segmented into a series of equal length message blocks. The algorithm starts with an initial value, the initialization vector (IV) which is algorithm specific. For each message block, a compression function takes the current result and updates it by combining it with the block. Bits representing the length of the message are padded with a fixed pattern (such as a one bit followed by zeros) as required and appended to the end of the message. The final value is taken as the message digest value or hash value.

Advances in cryptanalysis have identified weaknesses in the SHA and MD series of digest functions. Results show that the collision resistance of SHA-1 (which has a digest value of length N=160) is no more than 2⁶², which is substantially less than the 2⁸⁰ expected. This is the equivalent of reducing 15 years to 1 hour and makes the approach susceptible to a brute force attack. For the MD5 algorithm, where N=128, the collision resistance is no more than 2³⁰, which is substantially less than the 2⁶⁴ expected.

Message digests can be strengthened in several ways by simple preprocessing of the message string to be digested. One approach is to whiten the input string by periodically inserting additional fixed characters, such as zeros. For example, four zero bytes could be inserted after each 12 message bytes. Another approach is to lengthen the message by duplicating message bytes. These techniques work by restricting the possible input values after preprocessing in such a way as to make it hard to construct pairs of inputs with a higher than random chance of producing colliding digests. Thus, the function is more secure against attacks on collision resistance.

For many applications, it has been found desirable to use a truncated message digest. Using a message digest with no more bits than needed is more efficient than using a larger value. Furthermore, using a message digest function that produces a longer value and then truncating the value to L bits may, because of stronger processing, results in as strong a message digest at its indicated length, despite the weaknesses described above. That is, a length N digest truncated to length L may be stronger than a full length digest of length L. 160 bit SHA-1 truncated to 96 bits is used in some standard Internet protocols, for example IPSEC and TLS.

It is desirable that a base digest of length N bits that is truncated to length L-bits should be different in output value from the full length function. It is also desirable that the same algorithm should give different outputs for different lengths L. Having the base message digest functions for different truncation lengths produce different outputs improves the probability of rejection in the case of truncation mismatch. In addition, an attacker gains no advantage by attempting to guess the extensions of truncated values.

One way to make the truncated message digest dependent upon the length L is to use a different initialization vector (IV) for each different truncation length. For example, SHA-224 is defined by NIST as identical to SHA-256 except that a different IV is used and the output is truncated. The same is true for SHA-384 and SHA-512.

However, a disadvantage of this approach is that many initialization vectors may be required, using substantial memory for storing all of the vectors.

### BRIEF DESCRIPTION OF THE DRAWINGS

The novel features believed characteristic of the invention are set forth in the appended claims. The invention itself, however, as well as the preferred mode of use, and further objects and advantages thereof, will best be understood by reference to the following detailed description of an illustrative embodiment when read in conjunction with the accompanying drawing(s), wherein:

FIGS. 1-4 are diagrams of methods for generating truncated message digests consistent with certain embodiments of the present invention.

FIG. 5 is a flow chart of a method for generating truncated message digests consistent with certain embodiments of the present invention.

FIG. 6 is a flow chart of a further method for generating truncated message digests consistent with certain embodiments of the present invention.

### DETAILED DESCRIPTION

While this invention is susceptible of embodiment in many different forms, there is shown in the drawings and will herein be described in detail one or more specific embodiments, with the understanding that the present disclosure is to be considered as exemplary of the principles of the invention and not intended to limit the invention to the specific embodiments shown and described. In the description below, like reference numerals are used to describe the same, similar or corresponding parts in the several views of the drawings.

The present invention relates to the generation of truncated message digests. The truncated message digests are secure and provide a large range of truncation options.

Consistent with one embodiment of the invention, a truncated message digest of length L bits is generated by first preprocessed the data in a manner dependent upon the value L to obtain modified data, then segmenting the modified data into message blocks and initializing a vector of values. Each message block is used to update the vector of values. The truncated message digest is obtained by truncating the vector of values to L bits.

Consistent with a further embodiment, at least one additional byte is periodically inserted into the input data so that at least one additional byte appears in each block. At least one of the additional bytes is dependent upon the truncated length L. The message blocks resulting from the lengthened data are used to update the vector of values dependent upon the modified message blocks. Again, the truncated message digest is obtained by truncating the vector of values to L bits.

Consistent with a still further embodiment, at least one additional byte is periodically inserted into the input data such that at least one additional byte appears in each message block. At least one byte of the inserted bytes is a data byte combined with a byte dependent upon the truncated length L in a binary operation, such as an ‘exclusive or’ operation. The resulting blocks are used to update the vector of values. Again, the truncated message digest is obtained by truncating the vector of values to L bits.

It will be apparent to those of ordinary skill in the art, that different message blocks may use different modifications. For example, 3 bytes dependent on L (e.g., L represented as a 3 byte integer) could be inserted every 8 bytes of data, resulting in a pattern that repeats every 11 bytes. This is not an even multiple of the block sizes usually used, so the inserted 3 bytes would sometimes be entirely within a block and sometimes split between blocks. Furthermore, no change is needed in the implementation of existing hash functions. This advantage is realized if modifying the data, including dividing it into blocks and then processing it, is performed entirely before and outside of the hash processing.

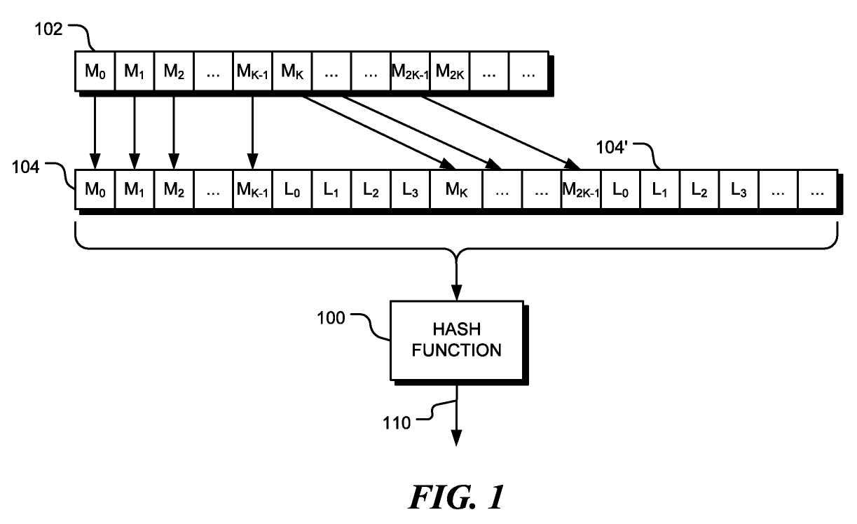

FIG. 1 is a diagram of a method for generating truncated message digests consistent with certain embodiments of the present invention. Referring to FIG. 1, a hash function 100 processes a message 102 that has been lengthened to produce message 104 by insertion of additional bytes. The message 102 to be digested (or hashed) is composed of a number of bytes labeled bytes M₀, M₁, M₂, etc. In a preprocessing step, the message is lengthened by periodically inserting a 32-bit (4-bytes) representation of the truncation length L such that this insertion occurs in each message block. The bytes are denoted in FIG. 1 by L₀, L₁, L₂ and L₃,with L₀ being the least significant byte and L₃ being the most significant byte. The message is thus lengthened. In the example, the 32-bit representation of the truncation length L is inserted every K bytes. However, more complex insertion patterns, including non-repeating patterns, may be used. The hash value 110 is truncated to length L.

The digest algorithm of the hash function 100 may process data N-bytes at a time. In this case, a fixed pattern and the length of the input data may be added to the end of the message to form a message of an integral number of blocks for the digest algorithm.

It will be apparent to those of ordinary skill in the art that here, and in the sequel, the value L used in preprocessing can be replaced by other values that are dependent upon L.

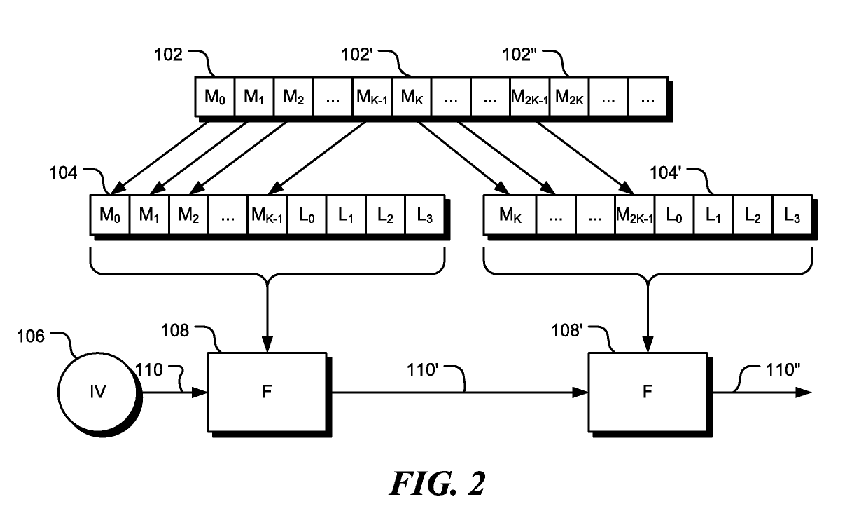

FIG. 2 is a diagram of a method for generating truncated message digests consistent with certain embodiments of the present invention. In FIG. 2, the digest algorithm of the hash function processes data N-bytes at a time. Preprocessing of the complete message may be performed prior to the computation of the hash function, resulting in a lengthened message. Alternatively, as shown in FIG. 2, the preprocessing may be performed on each block as it presented to the hash function. Blocks 102, 102′ and 102″ of K bytes are preprocessed by insertion of truncation length L (bytes L₀, L₁, L₂ and L₃). The number K and chosen so that lengthened message block has the appropriate length, N. For clarity, only one insertion is shown in each block in FIG. 2, however, in practice multiple insertions may be required. The message digest or hash is calculated using the lengthened data 104, 104′. In one embodiment of the invention, the message digest is calculated by sequentially updating an initialization vector (IV) 106 by calculating a function, F, of the initialization vector and the lengthened message block. The calculation is depicted by the boxes 108 and 108′ in FIG. 2. For example, the initial state vector 110 is combined with the lengthened data 104 to form state vector 110′ and the state vector 110′ is combined with the lengthened message block 104′ to form state vector 110″. The state vector stores intermediate results and has a length greater than or equal to L. This process is repeated until a specified number of lengthened message blocks have been added. The final state vector is truncated to length L to form the truncated message digest.

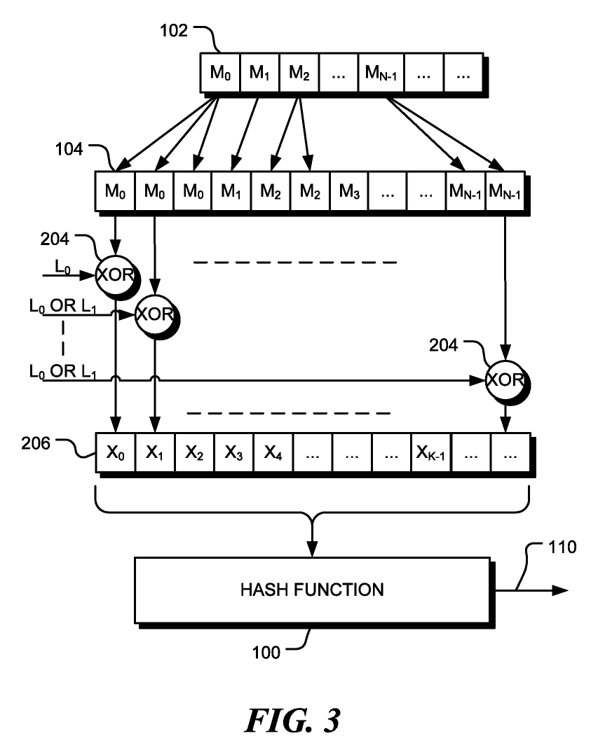

FIG. 3 is a diagram of a further method for generating truncated message digests consistent with certain embodiments of the present invention. Referring to FIG. 3, a hash function 100 processes a message 102 that has been lengthened to message 104 by insertion of additional bytes. The message 102 to be digested (or hashed) is composed of a number of bytes labeled bytes M₀, M₁, M₂, etc. The hash value 110 is truncated to length L. The message 102 is lengthened by periodic insertion of duplicate message bytes to give lengthened message 104. In the example shown in FIG. 3, the first byte, M₀, is duplicated twice, the second byte, M₁, is not duplicated and the third byte M₂ is duplicated once. However, other duplication patterns may be used.

The truncated message digest length L can be represented as the single byte L₀, if the length is less than 255. Otherwise the length is represented to by two bytes, L₀ and L₁. More bytes can be used if required for the system being designed to incorporate the disclosed invention.

As a further part of the preprocessing step, an exclusive or (XOR) operation is performed between duplicate bytes of a message being inserted and a byte of the truncation length, L. The XOR operation is depicted by the circles 204 in FIG. 3. In one embodiment, each XOR operation uses L₀. In a further embodiment, even numbered message bytes or inserted bytes use L₀ and odd numbered message byte or inserted bytes use L₁, or vice versa. Other variations will be apparent to those of ordinary skill in the art. The resulting modified data is used to calculate the message digest as described above. The modified message block 206 contains the bytes X₀, X₁, X₂, . . . , and is passed to hash function 100 to generate the message digest 110 that is truncated to L bytes.

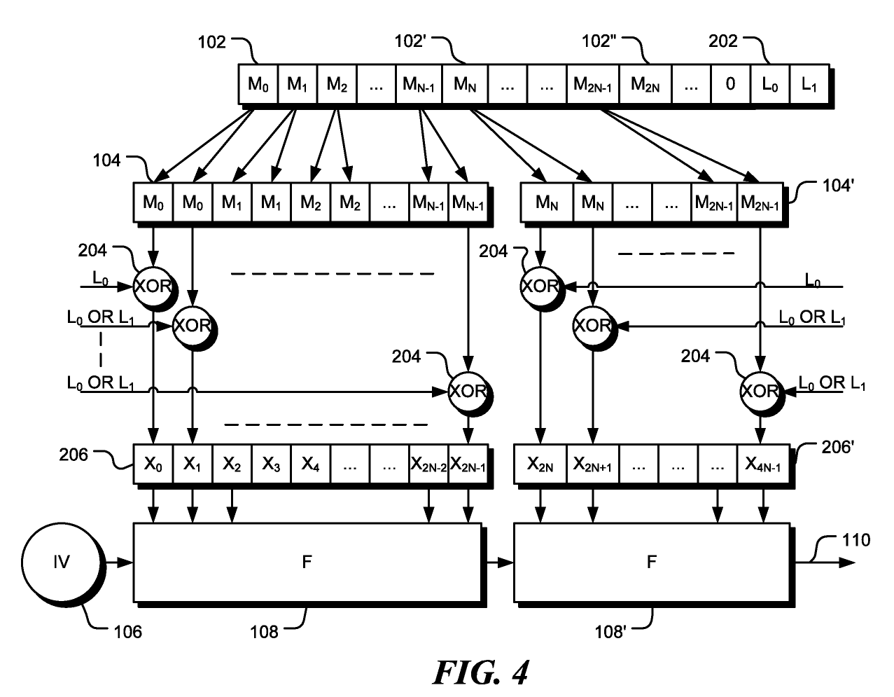

FIG. 4 is a diagram of a further method for generating truncated message digests consistent with certain embodiments of the present invention. The entire message may be preprocessed and then passed to an unmodified hash function, or, as shown in FIG. 4, the preprocessing may be applied to each block as it is used in the digest algorithm. This latter approach may reduce the amount of memory required,

Referring to FIG. 4, a message to be digested (or hashed) is composed of a number of blocks 102, 102′, 102″ etc. Each block contains N bytes of information. For example, message block 102 contains message bytes M₀, M₁, M₂, . . . , M_{N-1} and message block 102′ contains message bytes M_{N}, M_{N+2}, . . . , M_{2N-1}. In a preprocessing step, the data is lengthened by repeating some or all of the bytes of the message block. In this example, each byte is repeated once, however, other duplication and insertion patterns may be used. The truncated message digest length L can be represented as the single byte L₀, if the length is less than 255. Otherwise the length is represented to by two bytes, L₀ and L₁. More bytes can be used, if required for the system being designed to incorporate the disclosed invention.

As a further part of the preprocessing step, an exclusive or (XOR) operation is performed between duplicate bytes of a message being inserted and a byte of the truncation length, L. The XOR operation is depicted by the circles 204 in FIG. 4. In one embodiment, each XOR operation uses L₀. In a further embodiment, even numbered message bytes or inserted bytes use L₀ and odd numbered message byte or inserted bytes s use L₁, or vice versa. Other variations will be apparent to those of ordinary skill in the art. The resulting modified data is used to calculate the message digest as described above. The modified message block 206 contains the bytes X₀, X₁, X₂, . . . , X_{2N-1}.

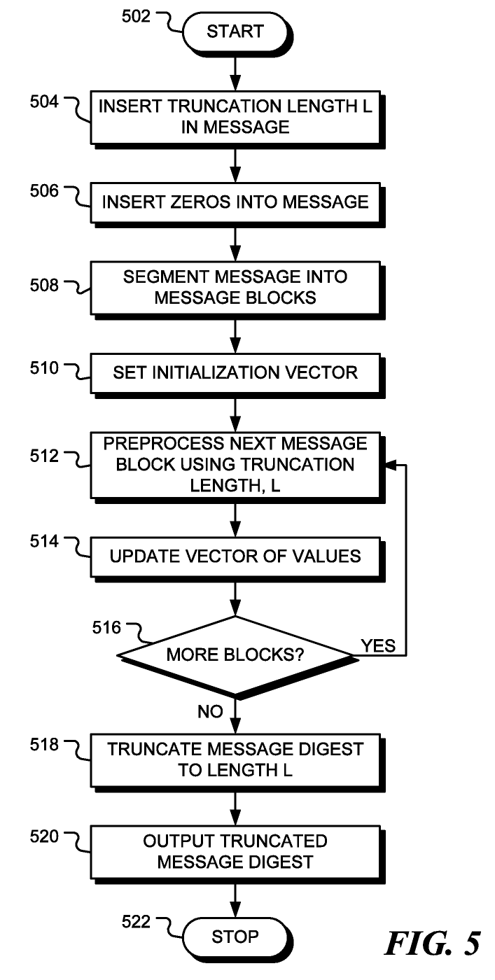

FIG. 5 is a flow chart of a method for generating truncated message digests consistent with certain embodiments of the present invention. The process begins at start block 502. Optionally, at block 504, the truncation length L is incorporated into the message M⁰={M₀, M₁, M₂, . . . , M_{J-1}}. This may be done, for example, by appending the truncation length to the message to give a message M={M₀, L}={M₀, M₁, M₂, . . . , M_{J-1}, L₀, L₁}. At block 506 zeros may be inserted to bring the message to the length required by the chosen algorithm. At block 508 the message is segmented into message blocks such that M={B₀, B₁, B₂, . . . }, where Bᵢ={M_{iK}, M_{iK+1,}M_{iK+2}, . . . , M_{iK+K-1}} is the i^{th} message block.

At block 510, a vector of values is initialized to values specified by an initialization vector. At block 512 a message block is preprocessed using a preprocessing function φ that is dependent upon the truncation length L. This gives a modified message block Xᵢ=φ(Bᵢ, L). In one embodiment the preprocessing function is φ{Bᵢ, L)={M_{iK}, M_{iK+1}, M_{iK+2}, . . . , M(_{i+1)K-1}, L₀, L₁, L₂, L₃}. In the MD5 algorithm, for example, each block contains 64 bytes, so K is set to 60 when this embodiment is used with the MD5 algorithm. In general, if the digest algorithm uses N bytes, K is set to N−4.

In a further embodiment the preprocessing function is φ{Bᵢ, L)={M_{iK}⊕L₀, M_{iK}⊕L₀, M_{iK+1}⊕L₀, M_{iK+1}⊕L₀ . . . , M_{(i+1)K-1}⊕L₀}, where ⊕ denotes the ‘exclusive or’ (XOR) operation. In this embodiment each bytes of the message block is duplicated and combined with the byte L₀ in an XOR operation. Alternatively, the XOR operation is performed first and then the bytes are duplicated. In a still further embodiment, the preprocessing function is φ{Bᵢ, L)={M_{iK}⊕L₀, M_{iK}⊕L₁, M_{iK+1}⊕L₀, M_{iK+1}⊕L₁, . . . , M_{(i+1)K-1}⊕L₀, M_{(i+1)K-1}⊕L₁}. In this embodiment each byte of the message block is duplicated and then even numbered bytes are combined with the byte L₀ in an XOR operation and odd numbered bytes are combined with the byte L₁ in an XOR operation. In the MD5 algorithm, for example, each block contains 64 bytes, so K is set to 32 when this embodiment is used with the MD5 algorithm. In general, if the digest algorithm uses N bytes, K is set to N/2. In a still further embodiment the preprocessing function is φ{Bᵢ, L)={M_{iK}, M_{iK}⊕L₀, M_{iK+1}, M_{iK+1}⊕L₀ . . . , M_{(i+1)K-1}, M_{(i+1)K-1}⊕L₀} or the similar function using L₀ and L₁, where only one of the duplicated bytes is modified by an XOR with an L byte.

It will be apparent to those of ordinary skill in the art that the XOR operation in the example embodiments described above could equivalently be replaced by other operations. Further, the operation could be carried out on every byte or only on selected bytes.

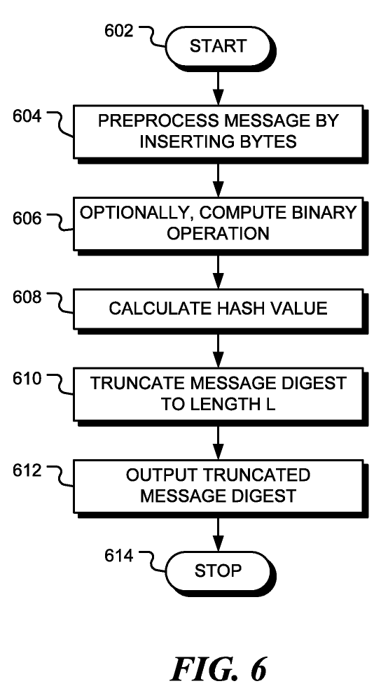

FIG. 6 is a flow chart of a further method for generating truncated message digests consistent with certain embodiments of the present invention. The process begins at start block 602. At block 604 the message is preprocessed by inserting additional bytes into the message to lengthen it. These bytes may be fixed bytes, bytes derived from the message block itself or bytes relating to the truncation length, L. In the case where bytes do not depend upon the truncation length, L, the message bytes are combined with bytes relating to the truncation length L in a binary operation. The order of these two operations may be reversed. Optionally, at block 606 in FIG. 6, an XOR operation is performed on each byte, as described above with reference to FIGS. 3 and 4. At bock 608, a digest value is computed from the lengthened message. At block 610, the full length digest value is truncated to length L-bits before being output at block 612. The process terminates at block 614.

In general, the preprocessing function comprises inserting additional bytes into a message to lengthen the message. These bytes may be fixed bytes, bytes derived from the message block itself or bytes relating to the truncation length, L. In the case where bytes do not depend upon the truncation length, L, the message bytes are combined with bytes relating to the truncation length L in a binary operation. The order of these two operations may be reversed.

The methods described above strengthen the message digest against certain recently discovered flaws and efficiently provides the maximum range of strong truncation options for protocol use. In addition, the methods incorporate the truncation length into the digest without out requiring a different initialization vector (IV) for each truncation length.

The present invention, as described in embodiments herein, is implemented using a programmed processor executing programming instructions that are broadly described above in flow chart form that can be stored on any suitable electronic storage medium. However, those skilled in the art will appreciate that the processes described above can be implemented in any number of variations and in many suitable programming languages without departing from the present invention. For example, the order of certain operations carried out can often be varied, additional operations can be added or operations can be deleted without departing from the invention. Error trapping can be added and/or enhanced and variations can be made in user interface and information presentation without departing from the present invention. Such variations are contemplated and considered equivalent.

Those skilled in the art will appreciate that the program steps and associated data used to implement the embodiments described above can be implemented using disc storage as well as other forms of computer readable media, such as, for example, Read Only Memory (ROM) devices, Random Access Memory (RAM) devices, optical storage elements, magnetic storage elements, magneto-optical storage elements, flash memory and/or other equivalent storage technologies without departing from the present invention. Such alternative storage devices should be considered equivalents.

While the invention has been described in conjunction with specific embodiments, it is evident that many alternatives, modifications, permutations and variations will become apparent to those of ordinary skill in the art in light of the foregoing description. Accordingly, it is intended that the present invention embrace all such alternatives, modifications and variations as fall within the scope of the appended claims.

What is claimed is:

1. A method for generating a truncated message digest of length L bits from a message, the method comprising:
preprocessing the message dependent upon the value L to obtain a modified message, the preprocessing comprising lengthening the message by insertion of additional values;
calculating a full length message digest from the modified message;
truncating the full length message digest to L bits to obtain the truncated message digest; and
outputting the truncated message digest.

2. A method in accordance with claim 1, wherein calculating a full length message digest from the modified message comprises:
segmenting the modified message into a plurality of modified message blocks;
initializing a vector of values; and
for each modified message block of the plurality of modified message blocks:
updating the vector of values dependent upon the modified message block;
wherein the vector of values comprises the full length message digest.

3. A method in accordance with claim 1, further comprising inserting the value L into the message.

4. A method in accordance with claim 1, further comprising inserting a value dependent upon the value L into the message.

5. A method in accordance with claim 1, wherein preprocessing the message comprises:
inserting additional bytes into the message to obtain a lengthened message; and
combining at least one byte of the lengthened message with a byte of the truncation length value L in a binary operation to obtain the modified message.

6. A method in accordance with claim 1, wherein preprocessing the message comprises inserting at least one additional byte into the message block, wherein a byte of the at least one additional bytes is dependent upon the truncation length value L.

7. A method in accordance with claim 1, wherein preprocessing the message block comprises:
duplicating at least one byte of the message at least once to obtain a lengthened message denoted by {M₀, M₁, M₂, . . . , M_{K-1}} and
executing a binary operation between bytes of the lengthened message and bytes L₀ and L₁ of the value L, to obtain the modified message block {M₀⊕L₀, M₁⊕L₁, M₂⊕L₀, M₃⊕L₁, . . . , M_{K-1}⊕L₁}, where ⊕ denotes the binary operation.

8. A method in accordance with claim 1, wherein a message comprises K bytes denoted by {M₀, M₁, M₂, . . . , M_{K-1}} and wherein preprocessing the message block comprises:
executing a binary operation, between bytes of the message and the least significant byte L₀ of the value L, to obtain an intermediate message {M₀⊕L₀, M₁⊕L₀, M₂⊕L₀, . . . , M_{K-1}⊕L₀}, where ⊕ denotes the binary operation; and
duplicating at least one byte of the intermediate message at least once to obtain the modified message.

9. A method in accordance with claim 1, wherein preprocessing the message comprises inserting a value dependent upon the truncation length value L into the message.

10. A method in accordance with claim 1, wherein a message is denoted by {M₀, M₁, M₂, . . . , M_{K-1}, M_{K}, . . . } and wherein preprocessing the message block comprises periodically inserting bytes L₀, L₁, L₂ and L₃ dependent upon the truncation length value L to obtain the modified message {M₀, M₁, M₂, . . . , M_{K-1}, L₀, L₁, L₂, L₃, M_{K}, . . . }.

11. A computer readable medium containing programming instructions which, when executed on a computer, generate a truncated message digest in accordance with the method of claim 1.

12. A truncated message digest generated by the method of claim 1.

13. A method in accordance with claim 1, wherein a value of the additional values is dependent upon the length L of the truncated message digest.

14. A method in accordance with claim 13, wherein the value of the additional values comprises the least significant byte of the value L.

15. A method in accordance with claim 13, wherein the value of the additional values comprises the least significant two bytes of the value L.

16. A method for generating a truncated message digest of length L bits from a message, the method comprising:
preprocessing the message dependent upon the value L to obtain a modified message;
calculating a full length message digest from the modified message;
truncating the full length message digest to L bits to obtain the truncated message digest; and
outputting the truncated message digest.

17. A method in accordance with claim 16, wherein the preprocessing comprising combining at least one value of the message with a value dependent upon the truncated length L in a binary operation and lengthening the message by insertion of additional values.

18. A method in accordance with claim 16, wherein the preprocessing comprises lengthening the message by insertion of additional values to obtain a lengthened message and combining at least one byte of the lengthened message with a byte dependent upon the truncated length L in a binary operation.

19. A method in accordance with claim 16, wherein the preprocessing comprises lengthening the message by insertion of additional values dependent upon the truncated length L.

20. A method for generating a truncated message digest of length L bits, the method comprising:
segmenting a message into a plurality of message blocks;
initializing a vector of values;
for each message block of the plurality of message blocks:
preprocessing the message block dependent upon the value L to obtain a modified message block of length N bytes; and
updating the vector of values dependent upon the modified message block;
truncating the vector of values to L bits to obtain the truncated message digest; and
outputting the truncated message digest.
